(19) United States
(12) Patent Application Publication
(10) Pub. No.: US 2026/0058692 A1
(43) Pub. Date: Feb. 26, 2026

(54) METHOD AND APPARATUS FOR COOPERATIVE RADAR TRANSMISSION ALLOCATION USING VEHICLE-TO-VEHICLE COMMUNICATIONS

(71) Applicant: Autotalks Ltd., Kfar Netter (IL)

(72) Inventor: Onn Haran, Kfar Netter (IL)

(21) Appl. No.: 19/218,720

(22) Filed: May 27, 2025

Related U.S. Application Data
(60) Provisional application No. 63/657,882, filed on Jun. 9, 2024.

(51) Int. Cl. H04B 7/024; H04B 17/345; H04B 17/373

(52) U.S. Cl. CPC H04B 7/024; H04B 17/345; H04B 17/373

(57) ABSTRACT

Methods and apparatus for cooperative radar transmission allocation using vehicle-to-vehicle (V2V) communications, a method comprising: in a self-vehicle: receiving from nearby vehicles respective enhanced V2V messages that include respective vehicle kinematics and respective enhanced radar parameters containers with respective nearby vehicle enhanced radar parameters, the enhanced radar parameters including timing parameters; based on the received nearby vehicle enhanced radar parameters, vehicle kinematics, and self-radar measurements, estimating and adjusting current and future interference levels between self-radars and the nearby vehicle radars to obtain adjusted current and future interference levels; and based on the adjusted current and future interference levels and on the timing parameters, calculating transmission parameters of all the self-radars, to allocate self-radar transmissions that minimize radar transmission interference.

### CROSS REFERENCE TO RELATED APPLICATIONS

This application is related to and claims priority from U.S. Provisional Patent Application No. 63/657,882 filed Jun. 9, 2024, which is incorporated herein by reference in its entirety.

### FIELD

Embodiments of the invention relate generally to radar use in vehicle-to-vehicle (V2V) communications (also simply referred to herein as “V2V”), and more particularly to methods and apparatus for cooperative radar transmission allocation using V2V communications in a way that minimizes or mitigates radar interference (or simply “interference”) by vehicles driving nearby.

As used herein, “cooperative radar transmission allocation” refers to the assignment of radar transmission timing and parameters while considering the parameters of radars of nearby vehicles, thereby facilitating cooperative operation among those vehicles.

### BACKGROUND

The increasing adoption of vehicles with radars raises the likelihood of mutual radar interference. Additionally, new vehicles are typically equipped with a plurality of (or “multiple”) radars, including a front radar and additional radars at each front and rear corner and on the sides (also referred to herein as “non-front facing” radars). A radar transmission from one vehicle can obstruct the radar receiver of another, either directly when radars face each other or indirectly when reflections from one radar mix with those from another.

Basic interference mitigation techniques have been developed, but they offer only limited effectiveness. These methods either detect interfering signals and discard the measurement, which compromises safety, or suppress reception periods, reducing the signal-to-noise ratio and detection range. Even with these mechanisms, false detections may still occur, posing significant safety risks.

FIG. 1A illustrates a typical radar configuration in a vehicle 100. Vehicle 100 is equipped with five radars. A front long-range radar 102 supports functions like automatic braking and adaptive cruise control. Front corner radars 104 and 106 provide cross traffic alerts from left and right, respectively. Rear corner radars 108 and 110 detect road users in adjacent lanes, enhancing safety during lane changes to the left and right.

FIG. 1B illustrates an example of radar interference. There are two interference sources: direct and indirect. Interference from vehicles traveling in opposite directions is particularly severe. For example, transmissions 112 from a vehicle 128 blind the radar function of a vehicle 122 and potentially of a vehicle 124. If radars of vehicles 122 and 124 transmit simultaneously, (transmissions 114 and 116 respectively), their received reflections will overlap, corrupting the measurement due to indirect interference. Side radars can also interfere with each other, such as a transmission 118 of the front left radar of a vehicle 130 and a transmission 120 of the front right radar of vehicle 128.

Coordinating radar transmissions among different vehicles is considered a potential solution to this issue. Research is ongoing under the concept of ISAC (Integrated Sensing and Communication), but no concrete framework has been established. The primary challenge lies in achieving real-time communication and transmission allocation that minimizes the interference. To clarify, as used herein, “allocation” refers to the action is setting “radar parameters” performed after a time duration (i.e. allocation time).

### SUMMARY

Embodiments disclosed herein provide solutions to the challenge above by incorporating enhanced radar parameters into V2V communications to achieve cooperative setting of radar transmission parameters (also referred to herein as “cooperative radar allocation”), i.e. setting of radar transmission parameters to avoid transmission overlaps in the same frequency, thereby reducing interference.

In various examples, there is provide a method for cooperative radar transmission allocation using V2V communications, comprising: in a self-vehicle having a plurality of self-vehicle radars (or simply “self-radars”): receiving from nearby vehicles respective enhanced V2V messages that include respective vehicle kinematics and respective enhanced radar parameters containers with respective nearby vehicle enhanced radar parameters, the enhanced radar parameters including timing parameters; based on the received nearby vehicle enhanced radar parameters, vehicle kinematics, and self-radar measurements, estimating and adjusting current and future interference levels between the self-radars and the nearby vehicle radars to obtain adjusted current and future interference levels; and based on the adjusted current and future interference levels and on the timing parameters, calculating transmission parameters of each of the self-radars such that self-radar transmissions are allocated to minimize radar transmission interference.

As used herein, “current interference” is the interference at the present positions of the self-vehicle and nearby vehicle. “Future interference” is interference estimated for future locations.

In some examples, a method further comprises, based on the calculated transmission parameters of each of the self-radars, transmitting a self-vehicle enhanced V2V message including a respective enhanced radar parameters container.

In some examples, the received nearby vehicle enhanced radar parameters include parameters received from at least one nearby vehicle non-front facing radar.

In some examples, the estimating current and future interference levels includes estimating direct and indirect interference levels. In some such examples, the estimating direct interference levels includes calculating interference levels from all nearby vehicle radars with a direct line of sight to the self-radars. In some such examples, the estimating indirect interference levels includes calculating a radar distance between the self-vehicle and an analyzed nearby vehicle radar, using the calculated radar distance to calculate a respective analyzed radar attenuation, checking whether emissions from nearby vehicle radars overlap with the emissions of the analyzed radar, and if yes, based on the radar attenuation and on the overlap, calculating the indirect interference of transmissions of the analyzed nearby vehicle radar on the self-radar transmissions.

In some examples, the adjusting current and future interference levels to obtain the adjusted interference levels includes calibrating a wireless channel model used in the estimation of the current and future interference levels by identifying a specific transmitting nearby vehicle radar that contributed to the measured interference levels, and using a difference between the measured interference levels and the estimated interference levels.

In various examples, a method as above or below may be stored on a non-transitory computer-readable medium including instructions executed by a processor in the self-vehicle.

In various examples, there is provided an apparatus for cooperative radar transmission allocation using V2V communications and installed in a self-vehicle having a plurality of self-radars, the apparatus comprising: a V2V radio for transmission and reception of enhanced V2V messages that include respective enhanced radar parameters containers, the enhanced radar parameters including timing parameters; an enhanced V2V stack unit for parsing nearby vehicle enhanced radar parameters containers having associated nearby vehicle enhanced radar parameters; a storage for storing the nearby vehicle enhanced radar parameters containers and associated vehicle kinematics; an interference estimator configured to, based on the nearby vehicle enhanced radar parameters, vehicle kinematics, and self-radar measurements, estimate and adjust current and future interference levels between each radar of the self-radar and the nearby vehicle radars to obtain adjusted current and future interference levels; and an allocator configured to, based on the adjusted current and future interference levels and on the timing parameters, calculate transmission parameters of each of the self-radars such that self-radar transmissions are allocated to minimize radar transmission interference.

In some examples, the allocator is further configured to, based on the calculated transmission parameters of each of the self-radars, transmit a self-vehicle enhanced V2V message with a respective enhanced radar parameters container.

In some examples, the enhanced radar parameters container includes fields with information on multiple non-front facing radars and specific future radar transmission timing.

In some examples, the received nearby vehicle enhanced radar parameters include parameters received from at least one nearby vehicle non-front facing radar.

### BRIEF DESCRIPTION OF THE DRAWINGS

Non-limiting examples of embodiments disclosed herein are described below with reference to figures attached hereto that are listed following this paragraph. Identical structures, elements or parts that appear in more than one figure are generally labeled with a same numeral in all the figures in which they appear. If identical elements are shown but numbered in only one figure, it is assumed that they have the same number in all figures in which they appear. The drawings and descriptions are meant to illuminate and clarify embodiments disclosed herein and should not be considered limiting in any way. In the drawings:

FIG. 1A illustrates a typical radar configuration in a vehicle;

FIG. 1B illustrates an example of vehicles experiencing radar interference;

FIG. 2 illustrates an exemplary method for cooperative radar transmission allocation using V2V disclosed herein;

FIG. 3 illustrates a block diagram of a cooperative radar transmission allocation apparatus using V2Vdisclosed herein;

FIG. 4 illustrates a flow chart of collecting received enhanced radar parameters from nearby vehicles;

FIG. 5 illustrates a flow chart of estimating current and future direct and indirect interference from all radars of nearby vehicles;

FIG. 6 illustrates an example of an enhanced radar parameters container disclosed herein;

FIG. 7A and FIG. 7B illustrate examples of cooperative radar transmission allocation.

### DETAILED DESCRIPTION

FIG. 2 illustrates a flow chart of cooperative radar transmission allocation using V2V, according to an exemplary method disclosed herein. The process is performed in a self-vehicle and begins at step 202, where enhanced V2V messages of nearby vehicles are received in the self-vehicle. As used herein, “enhanced V2V message” refers to a V2V message that includes an enhanced radar parameters container. The enhanced V2V messages include standard V2V messages such as Cooperative Awareness Message (CAM), Decentralized Environmental Notification Message (DENM), or

Collective Perception Message (CPM), along with the additional enhanced radar parameters container. The term “radar parameters container” (or for simplicity “radar container”) refers to an extension of data for a specific purpose, dedicated for radar parameters, which can be used by the receiving vehicle to mitigate cross interference. Nearby vehicles are identified using the self-vehicle's sensors, and those that are not detected, indicating a lack of a clear line of sight to the self-vehicle, are excluded for simplicity. The radar container describes the planned transmission parameters of all the vehicle's radars, enabling nearby vehicles to coordinate their radar transmissions (including of non-front facing radars) accordingly.

An enhanced radar container disclosed differs from known radar containers in that its content includes fields with information on multiple non-front facing radars and specific future radar transmission timing. The “enhanced” aspect of the radar parameters provided in an enhanced radar parameters container will become clearer below. In particular, the enhancement is reflected in the fact that the parameters include specific timing parameters (i.e. radar transmission duration and future transmission start times) and belong to multiple radars and specifically to non-front facing radars. For simplicity, in the context of this disclosure, “enhanced radar parameters” may be referred to as imply as “radar parameters”.

At step 204, current and future direct and indirect interferences from all radars of nearby vehicles are estimated and adjusted. A next period of allocation time is randomly generated each time radar parameters are allocated, the allocation time typically ranging between 1 and 4 seconds. For each radar on the self-vehicle, all nearby vehicles radars are evaluated for potential direct interference as well as for indirect interference resulting from the radar signal reflected by another nearby vehicle. For example, vehicle 126 is such a vehicle to the transmissions of vehicles 122 and 124. The interference calculation begins by identifying all possible direct and indirect propagation paths between the self-vehicle's radars and the radars of surrounding vehicles. Using determined distances, either directly between radars or, in the case of indirect paths, distances to and from a reflecting vehicle, the expected interference can be calculated in known ways based on a standard wave propagation model, considering radar height, frequency, and power.

Next, at step 206, transmission parameters of all self-vehicle radars (“self-radars”) are determined (calculated) for minimal interference, based on the estimated current and future levels of interfering energy or “interference levels” (also simply referred to herein as “interference” or “interferences”). Each radar's transmission time is selected to avoid interference where possible, e.g. by selecting a future transmission time and frequency in which no other interfering radar is expected to transmit. For example, if the 77-78 GHz band is congested, while the 78-78.5 GHz band is unoccupied, the latter should be selected for transmission without imposing any timing restrictions. For example, if if the selected frequency band is partially occupied, and if the required transmission duration is 20 milliseconds with anticipated interference occurring at 0 ms, 35 ms, and 80 ms, then the transmission may be scheduled to start between 55 ms and 60 ms in order to mitigate interference. If complete avoidance of interference is not feasible, i.e. there is no available time slot long enough to accommodate the entire transmission without overlapping with expected interference, the transmission time is chosen to minimize expected interference, which can be mitigated through adjustment of transmission parameters, such as by modifying the chirp rate or other waveform characteristics. For example, if the bandwidth is occupied, concurrent transmission with another radar is possible by applying a fixed frequency offset. This can be done by mimicking the other radar's chirp with a frequency shift. For example, if the interfering radar transmits at 78.6 GHz at a specific time, transmitting at 78.8 GHz at the same specific time with the same chirp shape avoids interference.

Finally, at step 208, radar parameters are periodically added to V2V messages as radar containers, typically once per second, and transmitted.

FIG. 3 illustrates a block diagram of an exemplary cooperative radar transmission allocation apparatus using V2V disclosed herein and numbered 300. Note that in general apparatus 300 comprises both hardware (HW) and software (SW) components. Apparatus 300 comprises a V2V radio 302 (HW) and an enhanced V2V stack unit (or simply “stack”) 304, normally implemented in SW. Apparatus 300 further comprises a plurality N of radars (HW components) 1 . . . . N marked 312 (for example, N=5), a “nearby vehicles identifier and radar parameters storage” unit 306 (also referred to as “storage 306”), an “estimator of nearby vehicles' direct and indirect interference for future locations” unit 308 (also referred to as “interference estimator 308”) and an “allocator of self-radars' transmission timing and parameters” unit 310 (also referred to simply as “allocator 310”). Units 306, 308 and 310 are implemented in SW.

V2V radio 302 handles the transmission and reception of enhanced V2V messages to and from enhanced V2V stack unit 304 through an interface 303. Stack 304 is responsible for generating and parsing the enhanced V2V stack. Hereinafter and for simplicity, the term “enhanced” may be dropped.

In use, upon receiving a radar container, stack 304 forwards it through an interface 305 for storage in storage 306, provided the transmitting vehicle has been corroborated by one of the self-vehicle's sensors by matching the location of the transmitting vehicle as received through a “perceived vehicles” interface 301 with the V2V location as received from stack 304. That confirms it as an immediate (adjacent) nearby vehicle (see more on this corroboration below). The stored radar container along the associated vehicle kinematics (e.g. speed, acceleration, heading, yaw rate) of the adjacent nearby vehicle is forwarded through an interface 307 to interference estimator 308. Estimator 308 calculates the future locations of all nearby vehicles using the vehicle kinematics, and estimates the direct and indirect interferences at each future locations for each of their radars. All interferences are laid down on a timeline, outlining the expected time and nature of each interference, and reported through interface 309 to allocator 310. Allocator 310 determines the optimal transmission time and frequency for all self-radars to minimize interference. Allocator 310 also initiates start of transmission by radars 312 via an interface 311. In other words, allocator 310 provides an ability to control accurately the start timing of the operation and to control externally the operational parameters of multiple radars through interface 311, the latter an action/feature not supported in known art. The allocated radar parameters (planned and future transmissions) are sent through an interface 315 to stack 304 for incorporation into V2V messages transmitted by V2V radio 302. If radars 312 detect interference, estimator 308 receives the measured interference level from radars 312 through an interface 313. If radar interference energy (interference levels) as estimated by the radar 312 receiver reaches a level that potentially leads to false detection (for example, if an effective noise level of radar reception increases by 10 dB), then a new allocation process is triggered immediately without waiting for the next allocation time.

FIG. 4 illustrates a flow chart of the collection of received radar parameters from nearby vehicles, expanding on step 202. The operation is performed in storage 306. The operation begins at step 402, when step 202 is executed for each specific nearby vehicle, one by one. Each specific nearby vehicle location, as received via V2V, is corroborated with its detected location from other onboard sensors of the self-vehicle, such as radar and cameras. If the V2V location of a specific nearby vehicle does not match a location detected by its own sensors, the specific nearby vehicle is considered to be “hidden”, i.e. it to have a minimal capacity to cause radar interference, and is therefore ignored. At step 404, if the specific nearby vehicle location matched, its radar parameters, as obtained from the V2V message, are stored for further processing.

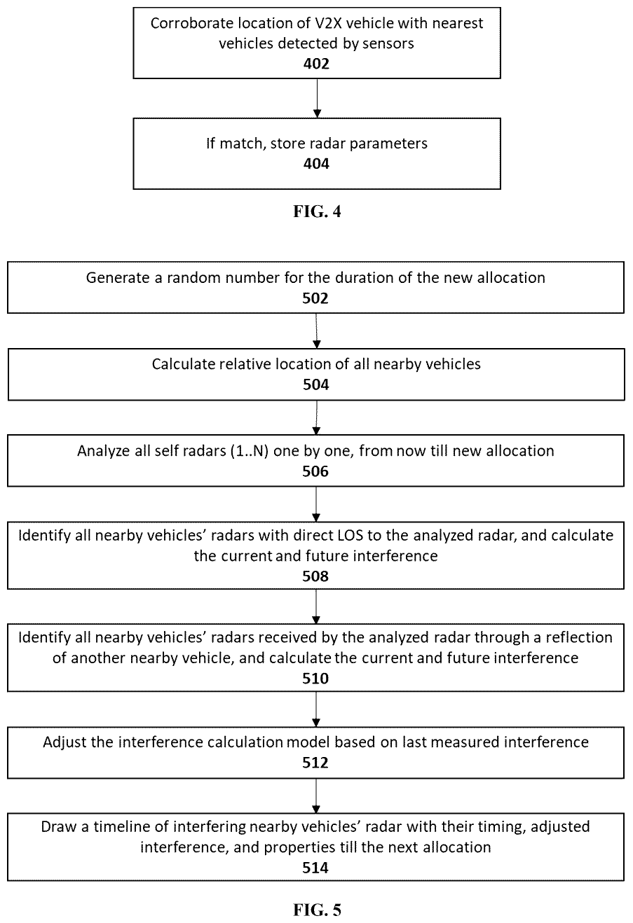

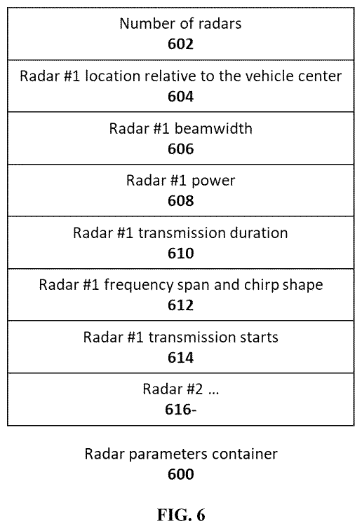

FIG. 5 illustrates a flow chart of the estimation of current and future direct and indirect interference from all radars of nearby vehicles, expanding on step 204. The operation is performed in interference estimator 308. The operation begins at step 502. A random duration for the new allocation is generated, typically ranging between 1 and 4 seconds. Next, at step 504, the location of nearby vehicles relative to the self-vehicle (“relative location”) is calculated for the allocation duration. For example, if the duration is 4 seconds, then the relative location is calculated 1, 2, 3 and 4 seconds ahead. The calculation is based on standard movement equation, using self and nearby vehicles speed, heading and acceleration. For example, if the self-vehicle is traveling in the opposite direction of the nearby vehicle, if the relative speed between them is 40 meters per second, and if the interference is to be estimated over a prediction horizon of 3 seconds, then given a current distance of 200 meters, the interference estimates will correspond to predicted distances of 170 meters, 140 meters, and 110 meters at 1, 2, and 3 seconds ahead, respectively.

Next, at step 506, a loop that checks (analyzes) N self-radars one by one, from 1 to N, is initiated to allocate radar parameters for all self-radars. The checked radar is defined as “analyzed radar”. If the self-vehicle has only a front radar, the steps are executed once, whereas a vehicle with additional corner radars repeats steps 508-514 for each radar, overall and exemplarily (for N=5) five times.

Next, at step 508, all radars of all nearby vehicles with direct line of sight (LOS) are identified, and interference between them and the self-radars is calculated per time (i.e. for current and future locations, where the future locations are calculated at 1 second steps). A nearby vehicle radar is considered to cause direct interference when the sum of the relative angle of the nearby vehicle with respect to the self-vehicle frame and the transmitting nearby radar's orientation relative to the nearby vehicle frame and 180°, including its beamwidth, encompasses the angular position of the analyzed radar relative to the self-vehicle frame. In other words, direct interference is caused when the angle of the nearby (the “relative angle” above)+the radar angle (i.e. the radar's orientation relative to the vehicle center) in the nearby vehicle equal the radar angle in the self-vehicle+180°.

For example, the nearby vehicle is positioned at an angle of 30 degrees relative to the self-vehicle, and both vehicles share the same heading. The left rear corner radar of the nearby vehicle is oriented at 210 degrees with respect to its own center reference frame. Under this configuration, the radar transmission from the nearby vehicle will be received by the self-vehicle within an angular range of −(beamwidth/2) to +(beamwidth/2) relative to the self-vehicle frame. If the radar beamwidth is 60 degrees, the self-vehicle's front radar (oriented at 0 degrees) and front-right radar (oriented at 30 degrees) will both fall within the transmission beam and therefore experience direct interference.

The distance between the transmitting radar and the analyzed radar (i.e. the “radar distance”) is calculated based on the nearby and self-vehicle dimensions and then applied in a wireless propagation model to estimate signal attenuation, as follows:

Radar distance=distance between self-vehicle and nearby vehicle centers minus distance from self-vehicle center to self-radar minus distance from nearby vehicle center to nearby vehicle radar.

The interference level is calculated based on the signal attenuation. For example, assume both the self-vehicle and the nearby vehicle have a length of approximately 5 meters. If a rear-mounted radar of the nearby vehicle causes interference with a front-mounted radar of the self-vehicle, and the radar distance d between the vehicles is 30 meters, then the effective distance between the two radar units is approximately 25 meters. In such a case, the interference level is estimated using a two-ray ground reflection model. The received interference level E is calculated as:

$$E = transmission energy of nearby vehicle radar - 40 log ( d ) + 10 {log}_{10} ( self antenna gain \times height self - {radar}^{2} \times height nearby vehicle {radar}^{2} ) .$$

Next, step 510 checks whether emissions from nearby vehicle radars overlap with the emissions of the analyzed radar and calculates indirect interference. This occurs when the sum of the relative angle of the nearby vehicle with respect to the self-vehicle frame and the transmitting radar's orientation relative to the nearby vehicle frame, including its beamwidth, encompasses the angular position of the analyzed radar relative to the self-vehicle frame. Additionally, a nearby vehicle must be located in the angular position of the analyzed radar relative to the self-vehicle frame to be considered in this indirect interference calculation. The interference calculation adds the estimated interference from the self-vehicle analyzed radar to the radar reflection of the reflecting nearby vehicle and to the interference from the transmitting radar to the same reflecting nearby vehicle.

For example, the self-vehicle and a nearby vehicle are traveling side-by-side in adjacent lanes. A third vehicle is positioned ahead of the self-vehicle, aligned at 0 degrees relative to the self-vehicle, and at 30 degrees relative to the nearby vehicle. If a front radar of the nearby vehicle has a beamwidth exceeding 60 degrees, the transmitted signal will reflect off the third vehicle and be received by a front radar of the self-vehicle. The effective distance of the reflected signal would be approximately twice the distance between the self-vehicle and the third vehicle.

Next, step 512 adjusts the interference calculation based on recently measured (“actual”) interference, measured by radar 312 and provided through interface 313, if available.

Steps 508 and 510 calculate the interference based on a wireless channel model, i.e. provide a “calculated” interference. However, wireless channel models are statistical in nature and may deviate from actual measurements. Furthermore, vehicles assumed to directly interfere with each other may be blocked by another obstructing object, which was unknown during the calculations of 508 and 510. If the radar is capable of accurately measuring interference, the deviation between the calculated interference and the measured interference is utilized at step 512 to calibrate the wireless channel model.

The calibration process begins by identifying the specific transmitting radar (among nearby vehicles) that contributed to the measured interference of the analyzed radar. This identification is based on a comparison between the transmission time indicated in the received V2V message and the transmission time of the analyzed radar. If multiple radars are determined to have transmitted concurrently with the analyzed radar, the radar with the strongest interference signal is selected. The difference between the measured interference and the calculated interference is then used to adjust the estimated interference between the identified transmitting radar and the receiving radar. That is, direct and indirect interferences are first estimated and then adjusted based on the measured interference.

For example, the analyzed radar measured an interference level of M dB. Upon retrospective analysis, it was determined that the only radar transmitting concurrently at the same frequency was associated with a vehicle X. The estimated interference level, whether direct or indirect, between the two radars was calculated to be E dB. The difference between the measured value (M dB) and the estimated value (E dB), (M dB-E dB), is referred to as “gap”, and can be either positive or negative, indicating that the actual measurement may exceed or fall below the estimation. To improve future estimations for this specific transmitting radar, the identified gap (which includes both estimated and measured interference levels) is applied as a correction factor. For example, an interference level estimate E at time T=1 second is adjusted as:

$$E [ T = 1 ] ( adjusted ) = E [ T = 1 ] dB + ( M dB - E dB ) .$$

This correction is only applied to the specific radar for which the measurement was obtained. Other radars, for which no such measurement exists, remain unadjusted in the estimation model.

Next, at step 514, a future interference timeline for the duration of the allocation (i.e the “allocation time”) is drawn, mapping expected energy levels and frequency usage by all transmitting radars of nearby vehicles (if any). This timeline includes all direct and indirect adjusted interferences based on their timing, adjusted interference and properties till the next allocation. If additional radars require processing, the operation loops back to step 506 to analyze the next radar.

FIG. 6 illustrates an example of an enhanced radar parameters container disclosed herein and numbered 600. Field 602 includes the number of radars in the vehicle. For example, a vehicle with only a front radar would have a value of 1, while a vehicle equipped with additional corner radars would have a value of 5 or more for advanced configurations. Following fields include each radar's specific parameters, beginning with Radar #1. Field 604 includes location, specifying the radar's relative position to the vehicle's center, including height. For example, a front radar has a lateral offset of 0 and a longitudinal value of half the vehicle's length. Field 606 includes beamwidth, defining the radar's horizontal and vertical beamwidth in degrees. Field 608 represents the transmission power in dBm. This parameter directly impacts interference levels, like front radars typically operate at higher power than corner radars. Field 610 represents the transmission duration in milliseconds. The parameters in fields 604, 606, 608 and 610 remain static.

While the parameters in the previous three fields remain static, following fields are dynamic. A field 612 includes frequency span, specifying the radar's operating frequency range and chirp shape, which may be adjusted in each allocation to mitigate interference. The chirp shape includes the positive and negative chirp rate in milliseconds, the initial frequency, and the first applied chirp. For example, the radar may use the 78.5-79 GHz band, starting at 78.7 GHz with a positive chirp at a rate of 100 MHz per 5 ms, followed by a negative chirp at 100 MHz per 1 ms. A field 614 includes transmission time, providing transmission timing details, including start time, and periodicities till next transmission. The periodicities may include one or more values. The periodicity values are reused, for example, if only 2 values are defined, then the future transmission times are [T, T+P1, T+P1+P2, T+P1+P2+P1,] and so on. These details allow receiving vehicles to construct a future transmission timeline for the radar transmissions of the self-vehicle. Parameters of additional radars are listed sequentially, starting from field 616 onward, i.e. there is a repeat of parameter listing in fields like fields 604-612 for radar #2, radar #3 . . . radar #N.

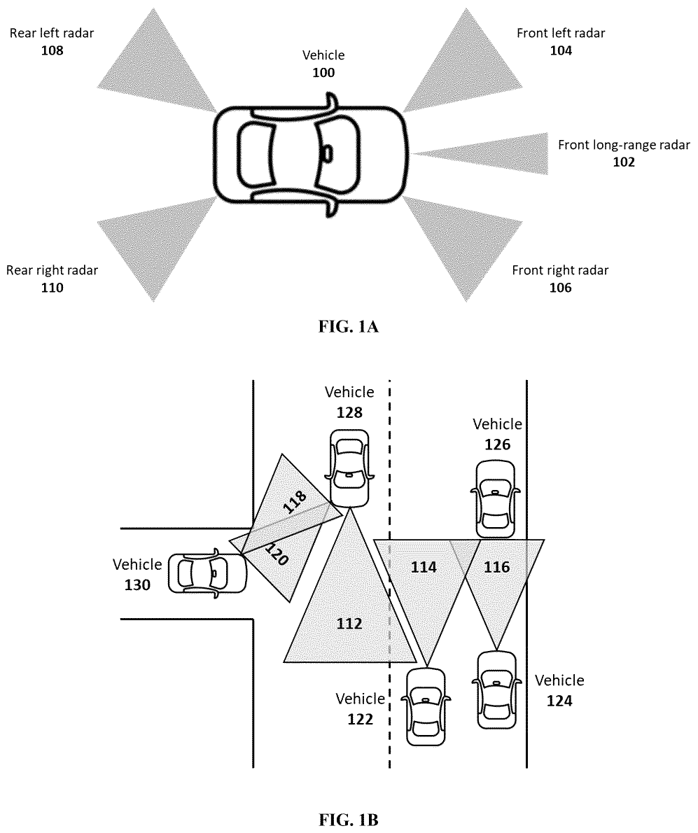

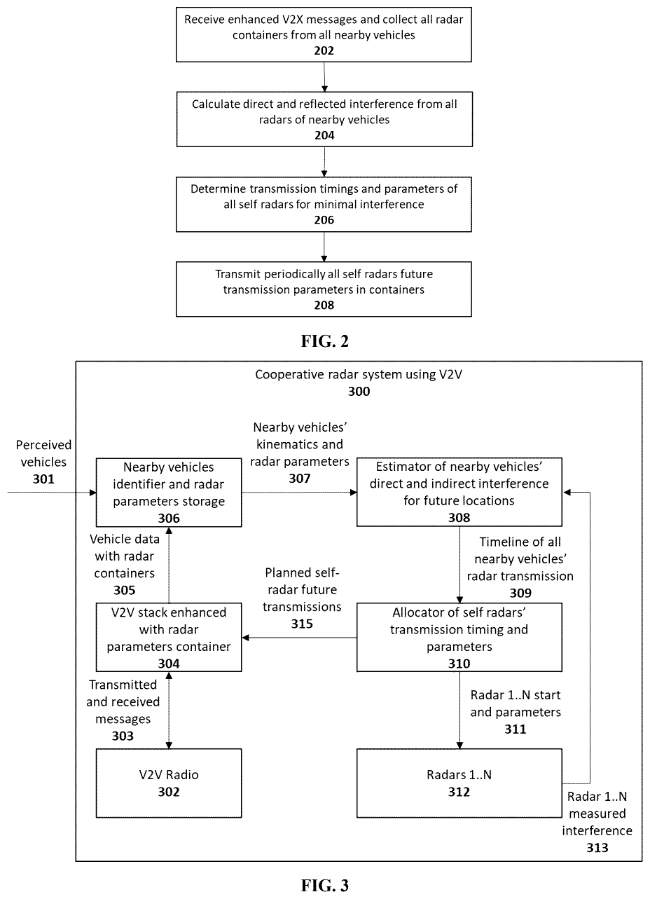

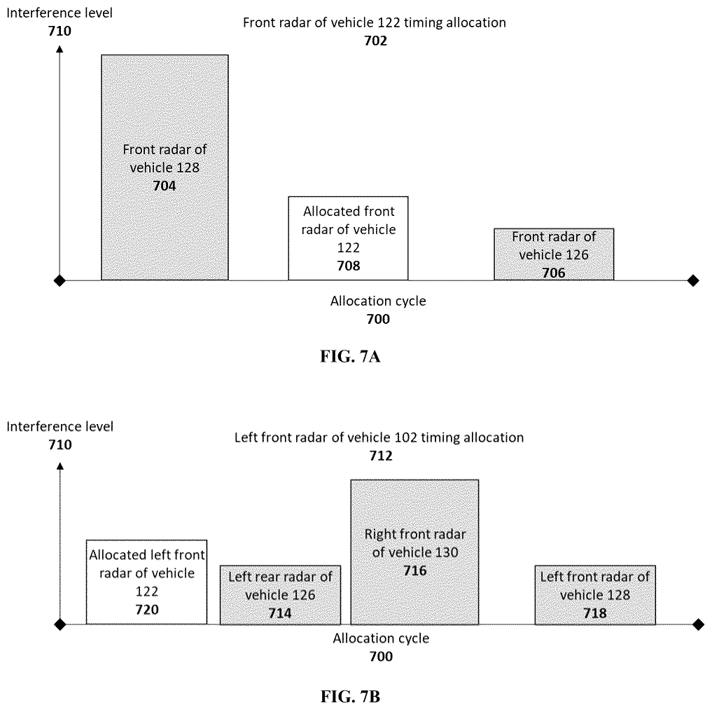

FIG. 7A and FIG. 7B illustrate examples of cooperative radar transmission allocation, with reference to the vehicles of FIG. 1B. The figures show two graphs FIG. 7A and FIG. 7B, in which the vertical axis represents an interference level 710. FIG. 7A illustrates the timing allocation for the front radar of vehicle 122. Block 704 represents high direct interference from the front radar of vehicle 128, which is traveling in the opposite direction and transmitting directly toward vehicle 122. Block 706 represents low indirect interference from the front radar of vehicle 124, which is moving in the same direction and positioned adjacent to vehicle 122. Its transmission is reflected off vehicle 126 before reaching vehicle 122, thus lowering the resulting interference. Block 708 represents the selected transmission period, ensuring that the allocated timing avoids overlap with both direct and indirect interferences.

FIG. 7B illustrates the timing allocation for the left front radar of vehicle 122. Block 714 represents direct interference from the front radar of vehicle 126, which is traveling in the adjacent lane in the same direction ahead of vehicle 122. Block 716 represents high direct interference from the front radar of vehicle 130, which is approaching from the left road and directly blinding the left front radar of vehicle 122. Block 718 represents direct interference from the left front radar of vehicle 128, which is traveling in the opposite lane to vehicle 122. Block 720 represents the selected transmission period, ensuring that the allocated timing avoids overlapping with all sources of interference.

It is appreciated that certain features of the presently disclosed subject matter, which are, for clarity, described in the context of separate examples, may also be provided in combination in a single example. Conversely, various features of the presently disclosed subject matter, which are, for brevity, described in the context of a single example, may also be provided separately or in any suitable sub-combination.

To clarify, any vehicle that includes an apparatus and performs a method disclosed herein may act as a self-vehicle.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

Some stages of the aforementioned methods may also be implemented in a computer program for running on a computer system, at least including code portions for performing steps of the relevant method when run on a programmable apparatus, such as a computer system or enabling a programmable apparatus to perform functions of a device or system according to the disclosure. Such methods may also be implemented in a computer program for running on a computer system, at least including code portions that make a computer execute the steps of a method according to the disclosure.

The computer program may be stored internally on non-transitory computer readable media. Similarly, an enhanced radar parameters container disclosed herein may be stored on a non-transitory computer readable medium. All or some of the computer program and/or the enhanced radar parameters container may be provided on a computer readable medium permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

What is claimed is:

1. A method for cooperative radar transmission allocation using vehicle-to-vehicle (V2V) communications, comprising: in a self-vehicle having a plurality of self-radars:
receiving from nearby vehicles respective enhanced V2V messages that include respective vehicle kinematics and respective enhanced radar parameters containers with respective nearby vehicle enhanced radar parameters, the enhanced radar parameters including timing parameters;
based on the received nearby vehicle enhanced radar parameters, vehicle kinematics, and self-radar measurements, estimating and adjusting current and future interference levels between the self-radars and the nearby vehicle radars to obtain adjusted current and future interference levels; and
based on the adjusted current and future interference levels and on the timing parameters, calculating transmission parameters of each of the self-radars such that self-radar transmissions are allocated to minimize radar transmission interference.

2. The method of claim 1, further comprising, based on the calculated transmission parameters of each of the self-radars, transmitting a self-vehicle enhanced V2V message including a respective enhanced radar parameters container.

3. The method of claim 1, wherein the received nearby vehicle enhanced radar parameters include parameters received from at least one nearby vehicle non-front facing radar.

4. The method of claim 1, wherein the estimating current and future interference levels includes estimating direct and indirect interference levels.

5. The method of claim 4, wherein the estimating direct interference levels includes calculating interference levels from all nearby vehicle radars with a direct line of sight to the self-radars.

6. The method of claim 4, wherein the estimating indirect interference levels includes calculating a radar distance between the self-vehicle and an analyzed nearby vehicle radar, using the calculated radar distance to calculate a respective analyzed radar attenuation, checking whether emissions from nearby vehicle radars overlap with the emissions of the analyzed radar, and if yes, based on the radar attenuation and on the overlap, calculating indirect interference of transmissions of the analyzed nearby vehicle radar on the self-radar transmissions.

7. The method of claim 1, wherein the adjusting current and future interference levels to obtain the adjusted interference levels includes calibrating a wireless channel model used in the estimation of the current and future interference levels by identifying a specific transmitting nearby vehicle radar that contributed to the measured interference levels, and using a difference between the measured interference levels and the estimated interference levels.

8. The method of claim 1, wherein the allocation of self-radar transmissions that minimize radar transmission interference includes selecting, for each self-radar and based on the estimated and adjusted interference levels, a future time and frequency in which no other nearby vehicle interfering radar is expected to transmit.

9. The method of claim 1, wherein the allocation of self-radar transmissions that minimize radar transmission interference includes adjusting transmission parameters for each self-radar by modifying a respective transmission chirp rate or other respective transmission waveform characteristics.

10. A non-transitory computer-readable medium including instructions executed by a processor in a self-vehicle that has a plurality of radars, to perform a method for cooperative radar transmission allocation using vehicle-to-vehicle (V2V) communications, the method comprising:
receiving from nearby vehicles respective enhanced V2V messages that include respective vehicle kinematics and respective enhanced radar parameters containers with respective nearby vehicle enhanced radar parameters, the enhanced radar parameters including timing parameters;
based on the received nearby vehicle enhanced radar parameters, vehicle kinematics, and self-radar measurements, estimating and adjusting current and future interference levels between the self-radars and the nearby vehicle radars to obtain adjusted current and future interference levels; and
based on the adjusted current and future interference levels and on the timing parameters, calculating transmission parameters of each of the self-radars such that self-radar transmissions are allocated to minimize radar transmission interference.

11. The non-transitory computer-readable medium of claim 10, wherein the method further comprises, based on the calculated transmission parameters of each of the self-radars, transmitting a self-vehicle enhanced V2V message including a respective enhanced radar parameters container.

12. The non-transitory computer-readable medium of claim 10, wherein the received nearby vehicle enhanced radar parameters include parameters received from at least one nearby vehicle non-front facing radar.

13. The non-transitory computer-readable medium of claim 10, wherein the estimating current and future interference levels includes estimating direct and indirect interference levels.

14. The non-transitory computer-readable medium of claim 13, wherein the estimating direct interference levels includes calculating interference levels from all nearby vehicle radars with a direct line of sight to the self-radars.

15. The non-transitory computer-readable medium of claim 10, wherein the adjusting current and future interference levels includes calibrating a wireless channel model used in the estimation of the current and future interference levels by identifying a specific transmitting nearby vehicle radar that contributed to the measured interference levels, and using a difference between the measured interference levels and the estimated interference levels to adjust the estimated interference levels.

16. Apparatus for cooperative radar transmission allocation using vehicle-to-vehicle (V2V) communications and installed in a self-vehicle having a plurality of self-radars, the apparatus comprising:
a V2V radio for transmission and reception of enhanced V2V messages that include respective enhanced radar parameters containers;
an enhanced V2V stack unit for parsing nearby vehicle enhanced radar parameters containers having associated nearby vehicle enhanced radar parameters;
a storage for storing the nearby vehicle enhanced radar parameters containers and associated vehicle kinematics, the enhanced radar parameters including timing parameters;
an interference estimator configured to, based on the nearby vehicle enhanced radar parameters, vehicle kinematics, and self-radar measurements, estimate and adjust current and future interference levels between each radar of the self-radar and the nearby vehicle radars to obtain adjusted current and future interference levels; and
an allocator configured to, based on the adjusted current and future interference levels and on the timing parameters, calculate transmission parameters of all the self-radars to allocate self-radar transmissions that minimize radar transmission interference.

17. The apparatus of claim 16, wherein the allocator is further configured to, based on the calculated transmission parameters of each of the self-radars, transmit a self-vehicle enhanced V2V message with a respective enhanced radar parameters container.

18. The apparatus of claim 16, wherein the enhanced radar parameters container includes fields with information on multiple non-front facing radars and specific future radar transmission timing.

19. The apparatus of claim 16, wherein the received nearby vehicle enhanced radar parameters include parameters received from at least one nearby vehicle non-front facing radar.
